(19) United States
(12) Patent Application Publication
(10) Pub. No.: US 2014/0372251 A1
(43) Pub. Date: Dec. 18, 2014

(54) WEB-BASED GIFTING SOLUTION WITH BROWSABLE GIFT GALLERY AND SELECTABLE PRICE POINT

(71) Applicant: Next One's On Me, Austin, TX (US)

(72) Inventor: Sara Fae Rodell, Austin, TX (US)

(21) Appl. No.: 14/311,188

(22) Filed: Jun. 20, 2014

Related U.S. Application Data
(63) Continuation-in-part of application No. 13/677,299, filed on Nov. 14, 2012, now abandoned.
(60) Provisional application No. 61/559,380, filed on Nov. 14, 2011.

(51) Int. Cl. G06Q 30/06; G06F 3/0484

(52) U.S. Cl. CPC G06Q 30/0641; G06F 3/04842
USPC 705/26.7; 705/27.1

(57) ABSTRACT

A method is disclosed for providing a gift to a recipient. The method includes providing a website on which is displayed a set of gifts and a set of selectable gift values; receiving input from a gift giver which includes (a) a designated recipient for a gift, and (b) gift criteria which includes a gift value selected by the gift giver from said set of selectable gift values; creating a URL associated with the designated recipient upon which is displayed a subset of said set of gifts that meet the gift criteria input by the gift giver; receiving, from the designated recipient, a selection of a gift from said subset of gifts; and sending the selected gift to the recipient.

### CROSS-REFERENCE TO RELATED APPLICATION

This application is a continuation-in-part of, and claims priority from, U.S. Ser. No. 13/677,299 (Rodell et al.), entitled “SYSTEMS AND METHODS FOR EXCHANGING GIFTS IN SOCIALLY FOCUSED CATEGORIES”, filed on Nov. 14, 2012, which is incorporated herein by reference in its entirety; which claims priority from U.S. Provisional Application No. 61/559,380, filed Nov. 14, 2011, having the same inventors and the same title, and which is incorporated herein by reference in its entirety.

### FIELD OF THE DISCLOSURE

The present disclosure relates generally to gifting solutions, and more particularly to a web-based gifting solution that allows a user to readily provide a personalized gift to one or more parties, and that also allows a recipient a choice in the gift they receive.

### BACKGROUND OF THE DISCLOSURE

Gifting is an important activity in modern society, both for social occasions and for business purposes. Traditional gifting, in which the gift giver visits a store and selects a gift for the recipient, offers the potential for providing a personalized, meaningful and unique gift. However, this approach is time intensive, and does not scale well to situations where gifts must be found for a large number of recipients (as may be the case, for example, for office Christmas gifts). Moreover, this approach offers few alternatives to the recipient in the event that they are unhappy with the selected gift.

### BRIEF DESCRIPTION OF THE DRAWINGS

FIG. 1 is a flow chart of an embodiment of a method for providing a gift to a recipient from a gift giver in accordance with the teachings herein.

FIGS. 2-18 are screenshots from an embodiment of a software program that may be utilized to implement the systems and methodologies disclosed herein.

### SUMMARY OF THE DISCLOSURE

In one aspect, a method for providing a gift to a recipient is disclosed. The method comprises providing a website on which is displayed a set of gifts and a set of selectable gift categories; receiving input from a gift giver which includes (a) a designated recipient for a gift, and (b) gift criteria which includes a gift category selected by the gift giver from said set of selectable gift categories; creating a URL associated with the designated recipient upon which is displayed a subset of said set of gifts that meet the gift criteria input by the gift giver; receiving, from the designated recipient, a selection of a gift from said subset of gifts; and sending the selected gift to the recipient.

In another aspect, a method for providing a gift to a recipient is disclosed. The method comprises accessing a website associated with a business entity on which is displayed a set of gifts and a set of selectable gift categories; and inputting, in response to a prompt from said web site, (a) a designated recipient for a gift, and (b) gift criteria which includes a gift category selected by the gift giver from said set of selectable gift categories; wherein the website generates an electronic message to the designated recipient, wherein the electronic message contains a URL associated with the designated recipient upon which is displayed a subset of said set of gifts that meet the gift criteria input by the gift giver, wherein the website receives, from the designated recipient, a selection of a gift from said subset of gifts, and wherein the business entity sends the selected gift to the recipient.

### DETAILED DESCRIPTION

In light of the foregoing issues, various systems and methodologies have been developed in the art for gift exchange. These include the ubiquitous gift card, which is typically in the form of a physical token having a set value associated with it, and which may be applied as a credit against the cost of goods or services at a merchant associated with the gift card. However, while gift cards expedite gifting and offer the recipient flexibility in gift choice, gift cards lack the personalized, meaningful and unique quality of a traditional gift. Moreover, the focus of gift cards on the monetary amount of the gift detracts from the emotional value of the gift.

Other gifting systems currently exist as well. For example, one existing system marketed under the name GiftRocket™ allows a party to purchase for a recipient an online gift card at any of a select group of businesses. After the recipient selects a business, the service delivers the gift electronically to the recipient's email account or Facebook wall, and sends a predetermined amount of money to the recipient via Paypal™. The money may then be used at the designated business. Once the recipient is in the designated business establishment, the recipient selects a “redeem” option provided in the message, a GPS system verifies their presence in the establishment, and the funds are deposited into their PayPal™ account. In this approach, the recipient still pays the merchant; however, the transaction is at net zero cost to them, since they have received PayPal funds to cover the transaction.

Another gifting service marketed under the name Jifiti™ allows gift givers to browse stores and send a gift to a recipient's email, phone or Facebook™ page. The recipient is able to select certain attributes of the gift, such as size, color and style, or can choose a different gift during redemption.

Still other gift exchange systems currently known to the art involve teaming approaches. For example, The Gifts Project™, FriendFund™, Giftiki™ and WePay™ are all creative gifting systems where groups team together to buy expensive objects for their friends by each contributing small amounts.

While the foregoing gifting systems and methodologies have many desirable attributes, existing systems and methodologies for gifting have various infirmities associated with them. For example, conventional gift cards are inconvenient in that they often do not offer flexibility in destination redemption choice, may require the user to have the card on them at the time of redemption, and if they are lost, they cannot typically be replaced. Additionally, the association of dollar value with the card makes the exchange akin to exchanging cash.

Other gifting systems developed to date also suffer from various infirmities. For example, the gifts offered through the GiftRocket™ or Jifiti™ systems, are essentially gifts of money, and hence are often perceived by consumers as being impersonal or are not suitable to certain classes of interactions, such as corporate gift exchange. Still other solutions, such as the teaming approaches exemplified by The Gifts Project™, FriendFund™, Giftiki™ and WePay™, are directed toward less frequent, more expensive, and occasion-driven gifting. Accordingly, there remains a need in the art for new systems and methodologies of gifting that overcome these infirmities.

It has now been found that some or all of these needs may be met by the systems and methodologies disclosed herein. In a preferred embodiment, a web-based gifting system and methodology is provided which includes a website on which a collection of gifts may be browsed. The website allows a gift giver to send a gift to a recipient merely by inputting (a) a price level for the gift, and (b) contact information (preferably including a name and email address) for the recipient. The website then generates a customized web page associated with a URL which is unique to the recipient (and preferably unique to the recipient's email address), and upon which all of the gifts from the collection of gifts that the gift giver specified are available for browsing by the recipient. The recipient may then choose a gift from the collection displayed on the customized web page.

In some embodiments, the gift giver may also recommend a specific gift, although the recipient preferably has the option to choose a different gift from the collection specified by the gift giver. In other embodiments, the gift giver may specify a particular category or theme for the gift, although again, the recipient preferably has the option to choose a gift from a different category at the same price level.

It will be appreciated that the foregoing systems and methodologies provide a gifting solution that has the advantages of a traditional gift, insofar as the gift received by the recipient is personalized, meaningful and unique. On the other hand, these systems and methodologies also offer the advantages of a traditional gift card in terms of the flexibility, speed and ease of use they offer, and are also easily scalable to situations in which a party needs to buy gifts for several recipients. However, unlike gift cards, the price of the gift is preferably not readily discoverable in the systems and methodologies disclosed herein. Consequently, these systems and methodologies provide a socially different alternative to traditional gift cards that provide gift givers with the convenience of flexible gifting, without the taboo associated with exposing the price of the gift.

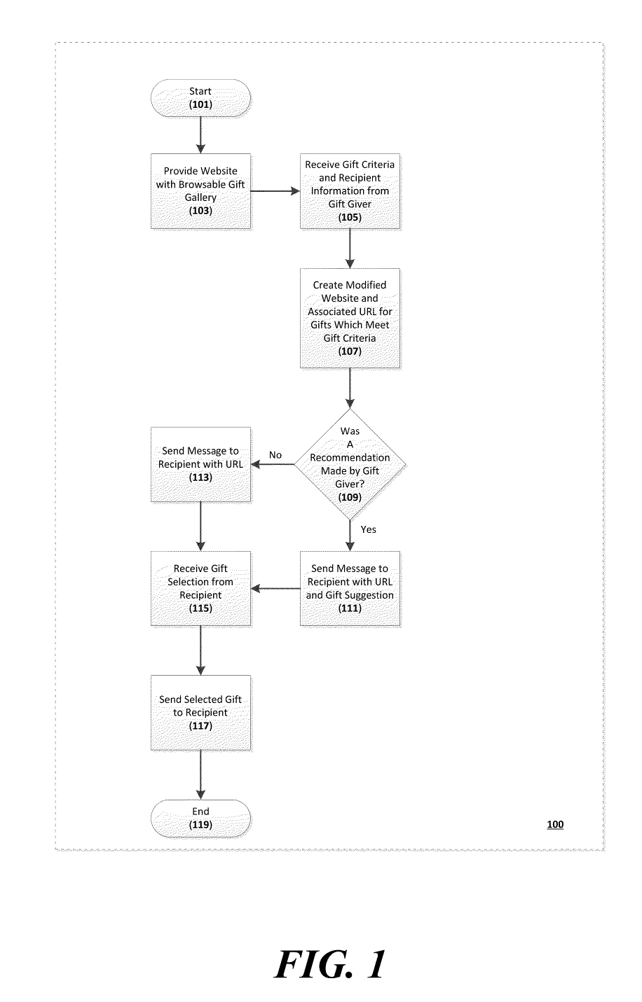

FIG. 1 illustrates a first particular, non-limiting embodiment of a web-based gifting solution 100 in accordance with the teachings herein. As seen therein, the underlying method commences 101 with the provision 103 of a website having browsable gift galleries thereon. The website is preferably maintained by a suitable business entity or organization. The gift galleries preferably include a variety of gifts, each having textual and pictorial descriptions associated therewith. Each gift in the gift galleries will have a price point associated with it. In a typical embodiment, several gifts will be provided at each price point to provide a gift giver with multiple options to choose from.

The gift giver then inputs 105 gift criteria into the website. In some embodiments, the input criteria may simply be a price point, which is preferably selected from a plurality of price points provided on the website. In other embodiments, the input criteria may include other options such as, for example, the general type of gift, or the requirement that the gift be chosen from a customized gift gallery (such as, for example, promotional or branded gifts associated with a particular business or organization, or gifts belonging to a certain genre, such as baby shower gifts). Preferably, however, the gift giver has the option to make a gift recommendation which is non-binding on the recipient, so that the recipient is free to choose any other gift at the price point selected by the gift giver.

After the gift criteria is received from the recipient, software associated with the website creates 107 a modified website (and associated URL) upon which are displayed all of the gifts from the gift gallery that meet the criteria input by the gift giver. The software determines 109 whether the gift giver made a gift recommendation. If so, the software generates a message (preferably in the form of an email, but possibly as a text message or other type of electronic message, or in a physical object, such as a card, in which the URL is printed, recorded, embedded or embodied) to the user which includes the recommendation, and sends 111 the message to the recipient at an email address or other location input by the gift giver. If the gift giver did not make a recommendation, then the software generates a message to the user which does not include a recommendation, and sends 113 the message to the recipient. In either case, the message includes a link to the modified website.

Upon receipt of the message, a recipient may select the link embedded in the message to navigate to the modified website with suitable browsing software installed on the recipient's device. Alternatively, if the URL is embodied or recorded in a tangible medium (such as, for example, a card), this link may be accessed or input by the user at a later time. Upon accessing the modified website, the recipient may choose the gift recommended by the gift giver (if a recommendation was made), or may choose any other gift from the collection specified by the gift giver. Upon receiving 115 a gift selection from the recipient, the software prompts the recipient for a mailing address to which the selected gift may be sent. The gift is then sent 117, and this portion of the process ends 119.

A typical embodiment of the foregoing process will have additional steps as well. For example, once a recipient chooses a gift and enters their shipping information, they will preferably have the option to send a “Thank You” note directly to the sender through the web-based gifting solution. Moreover, and regardless of whether the recipient chooses to send a “Thank You” note, the gift giver will preferably receive an email notification notifying them of the recipient's choice of a gift. The gift recipient will also preferably receive an email containing shipping tracking information for the gift.

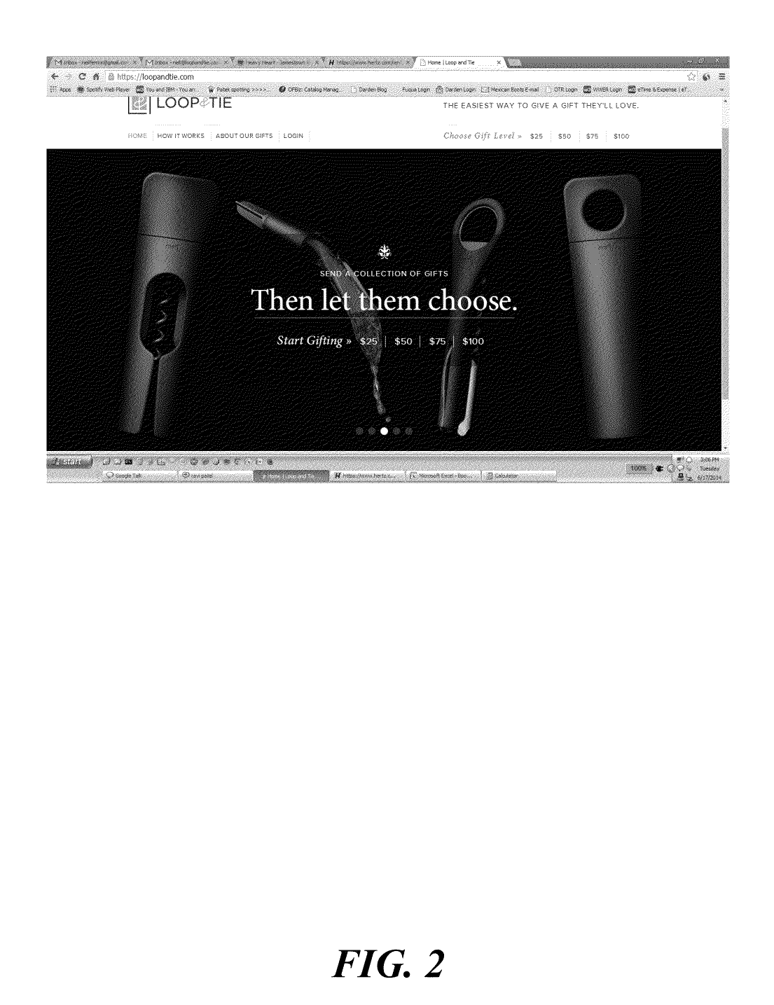

FIGS. 2-4 are screenshots from a particular, non-limiting embodiment of a website associated with the methodology of FIG. 1. With reference to FIG. 2, the home page 201 of the website in this particular embodiment includes a splash screen 203, which provides an overview of the gift solution reflected on the website. The home page 201 is also equipped with a price level field 205 which includes a plurality of selectable price levels for a gift. In the particular embodiment depicted, the price level field 205 includes price levels with denominations of $25, $50, $75 and $100, although it will be appreciated, in various embodiments, any suitable or desirable price levels, currencies or other gift categories (which may or may not be occasion based) may be utilized. The home page 201 is further equipped with navigational aids 207. These navigational aids 207, which are reproduced on several of the other web pages as well, allow a party accessing the web site to navigate to the home page, view an overview on the gifting solution implemented on the website, browse information about the gifts available on the website, and login to an account that was previously created.

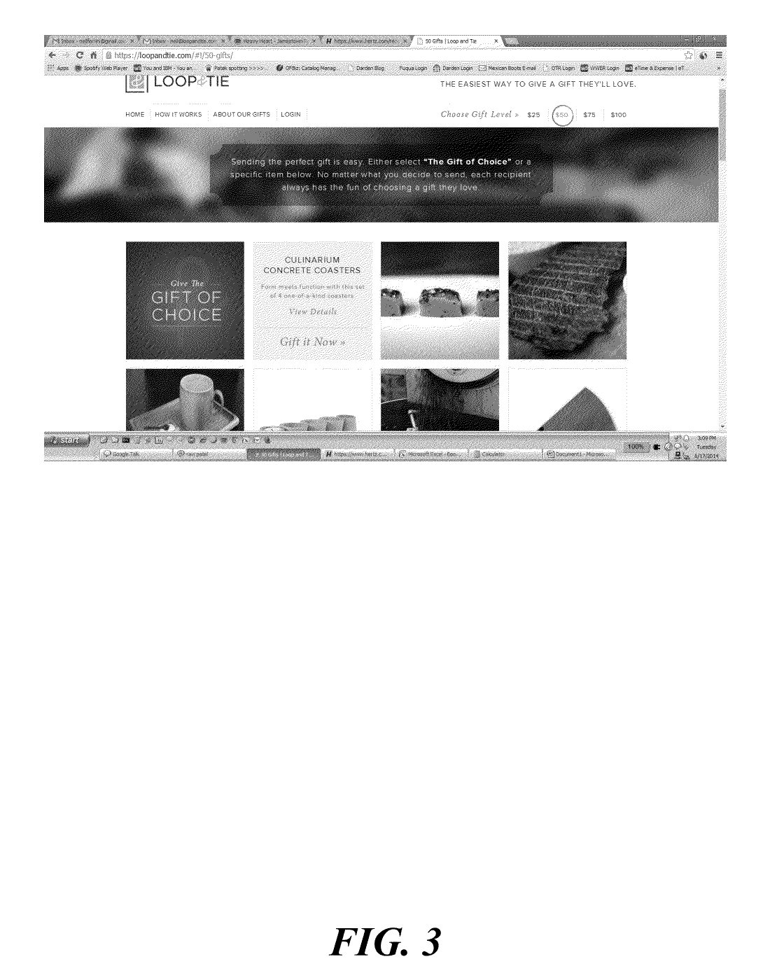

Selection of a price level in the price level field 205 launches a browsable gift gallery 209 of the gifts corresponding to that price level, as shown in FIG. 3. The gift giver may select a specific gift from the gift gallery 209 as a recommendation, or may choose a gift choice option 211 which allows the recipient to choose their own gift (this results in no gift recommendation being made).

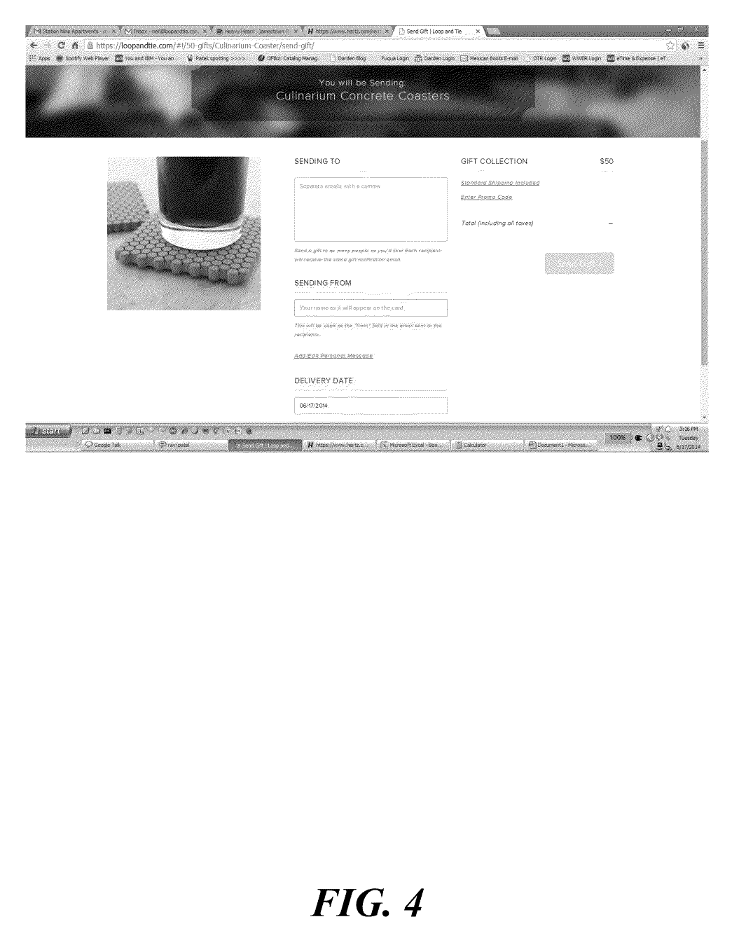

With reference to FIG. 4, once a gift is selected, the gift giver fills out a brief form 213. This form 213 includes fields for entering the gift giver's name (as it will appear to the recipient), the recipient's email address, and a scheduled delivery date. In the particular embodiment depicted, multiple email addresses may be entered (separated by a comma) to send the same gift to multiple recipients. However, it will be appreciated that, in other embodiments, gift recommendations for each recipient (or the gift of choice) may be selected independently. It will also be appreciated that, while email is a preferred means for sending gifts to recipients in the systems and methodologies described herein, other suitable means may be utilized for this purpose as well. These include, but are not limited to, various types of electronic messaging, including text messaging, as well as the use of messaging through social media sites or social networks sites such as Facebook™ or Twitter™.

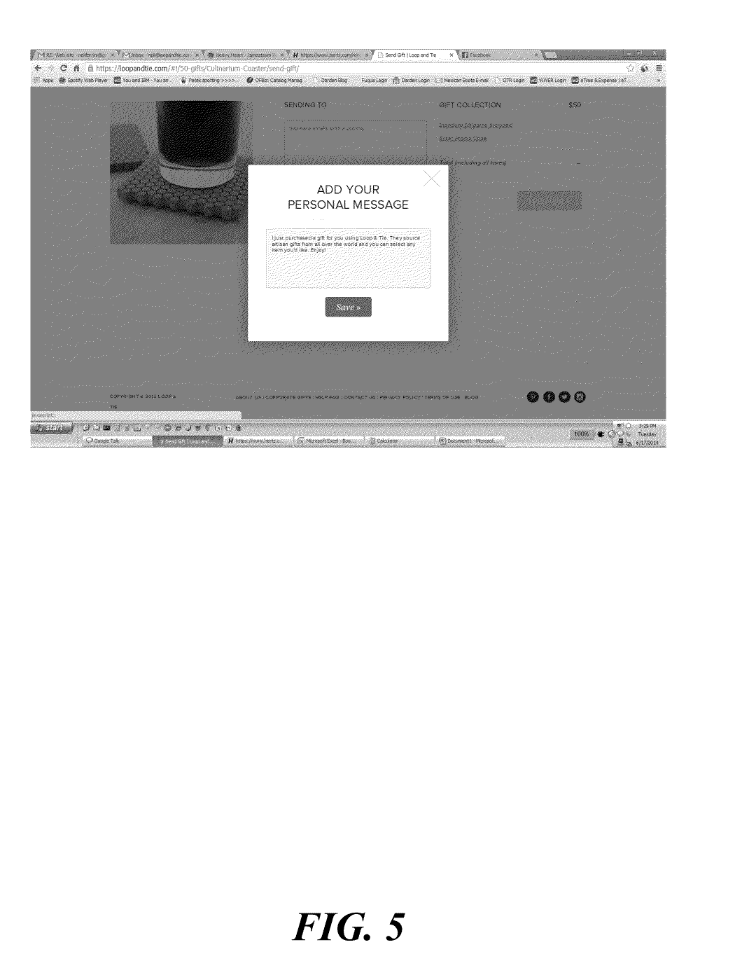

The form 213 further includes a selectable hyperlink 215 for adding a personal message to be sent to the recipient along with the gift notification (see below). Selection of this link 215 launches the window depicted in FIG. 5, in which the gift giver can enter a personal message 217 by modifying the standard or default message.

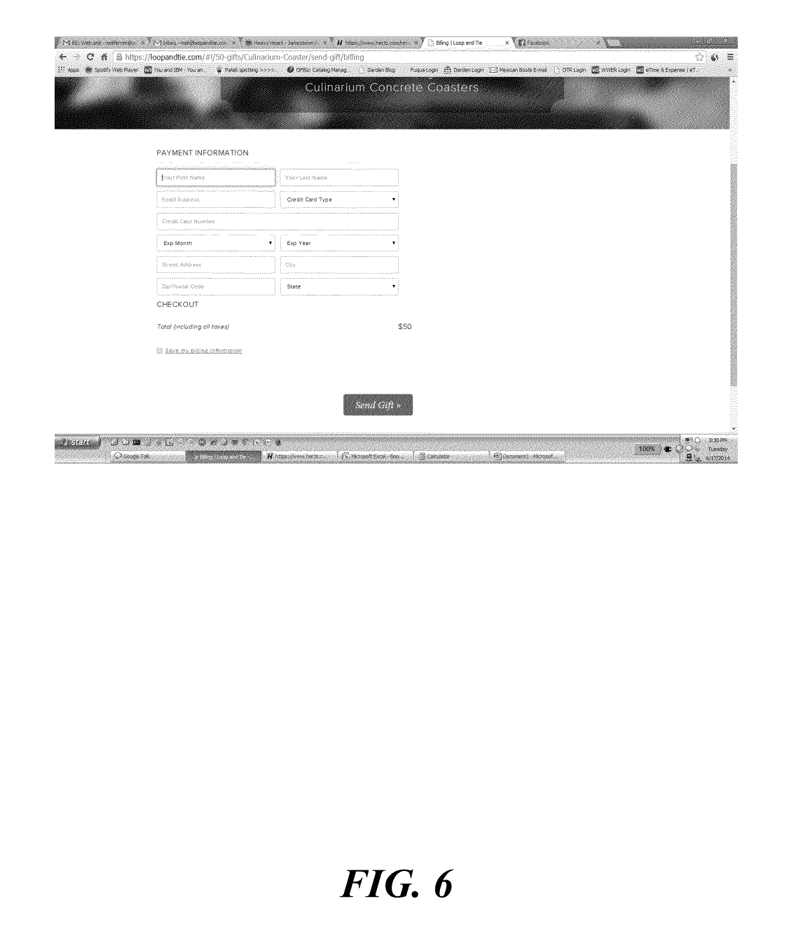

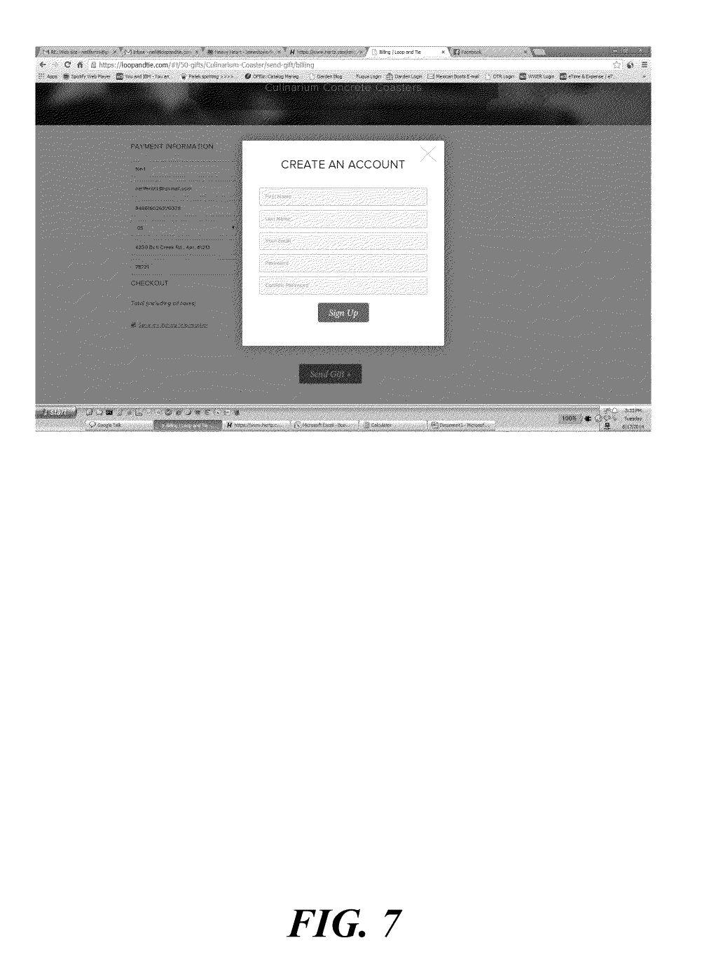

After entering the optional personal message 217, as seen in FIG. 6, a web page is presented on which the gift giver is queried for payment information 219. A hyperlink 221 is provided which the gift giver can utilize to save any entered payment information. Selection of the hyperlink 221 launches the screen 223 depicted in FIG. 7, on which the user enters information for the creation of an account. If payment information is saved for a user in this manner, the user may bypass the payment information screen of FIG. 6 in future transactions by logging in and using the stored payment information.

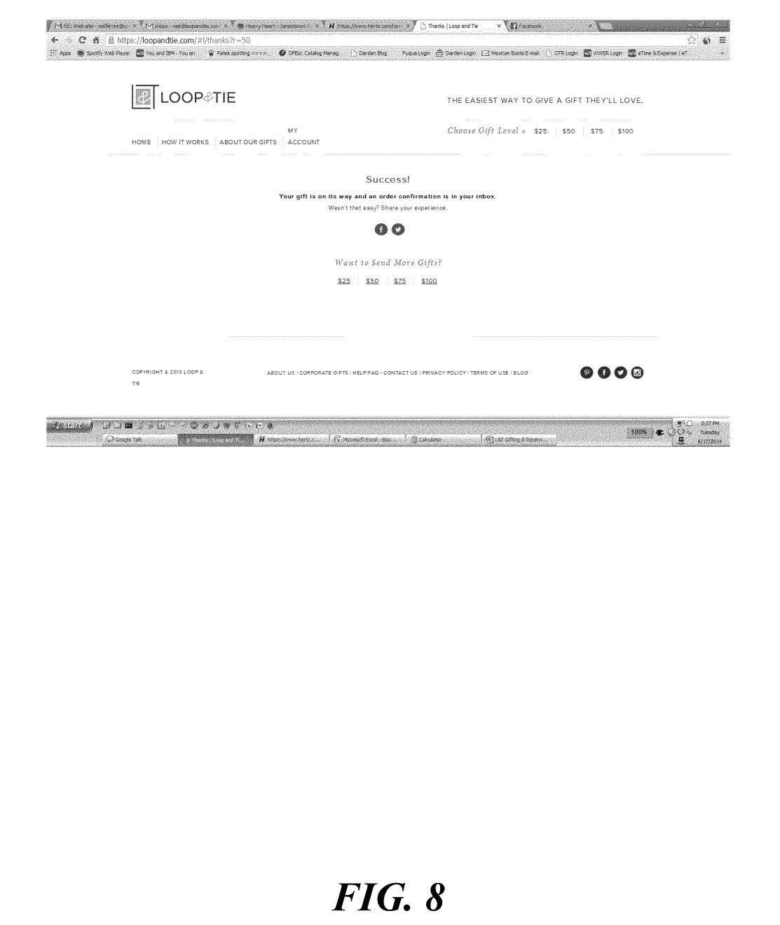

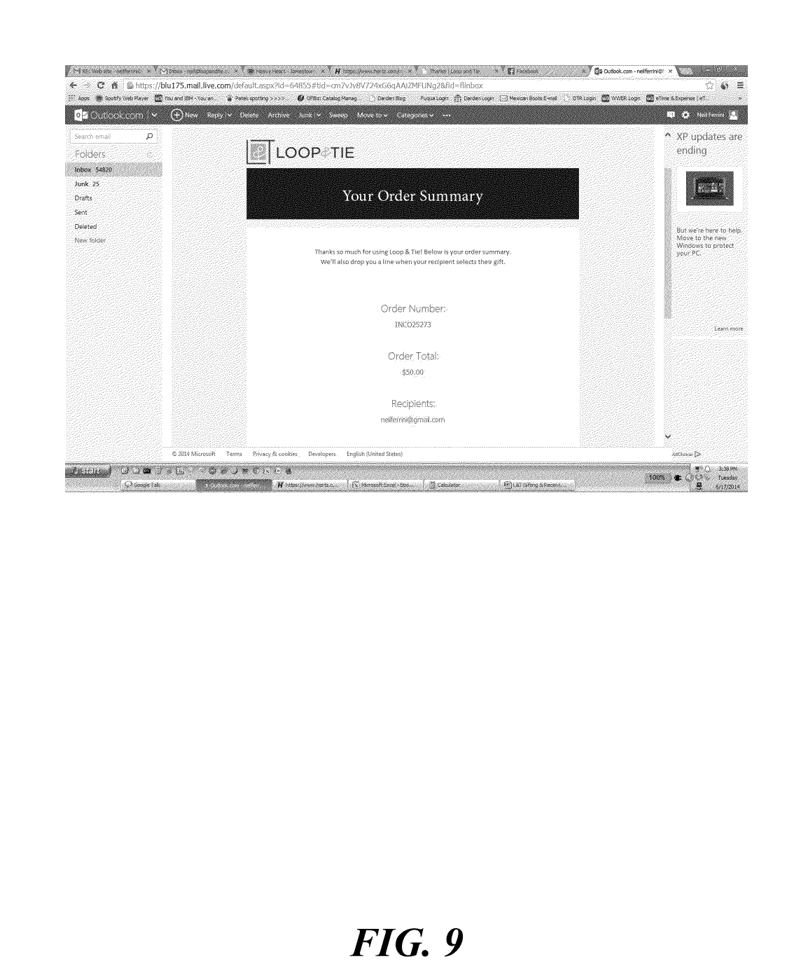

After payment information has been received from the gift giver as described above, a confirmation screen 225 is displayed confirming that the gift is in the process of being sent to the recipient, as shown in FIG. 8. An order summary 227 is then emailed to the gift giver, as shown in FIG. 9.

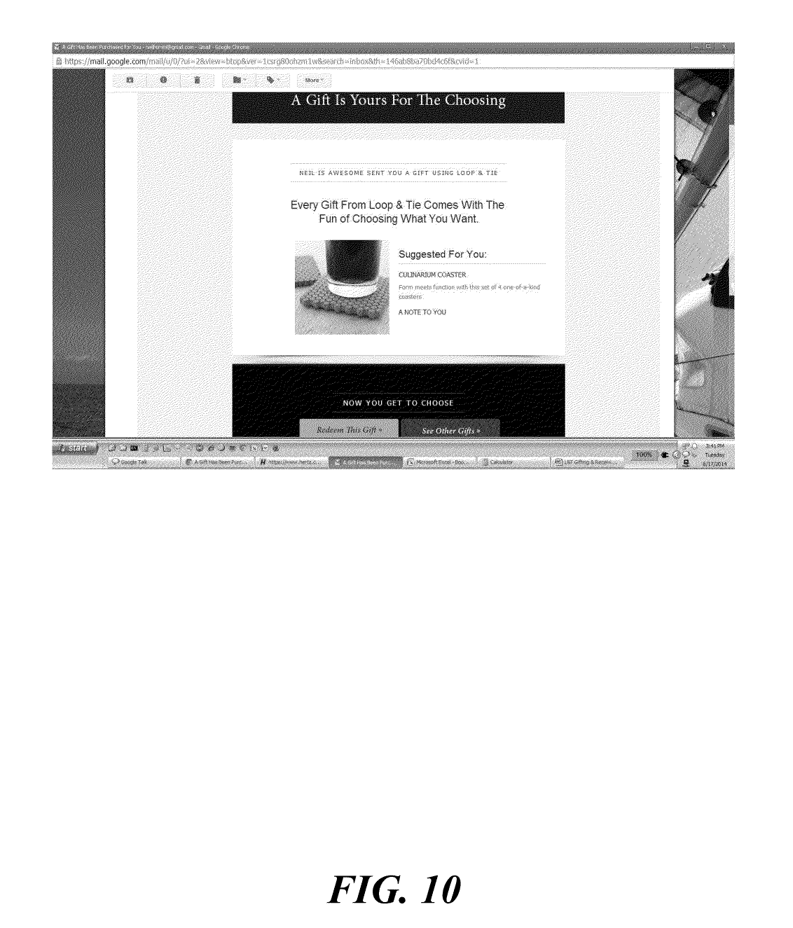

FIG. 10 depicts the email notification 229 received by the gift recipient as a result of the process described above. In the case depicted therein, the gift giver has made a gift suggestion 231. As seen therein, the recipient can redeem the suggested gift by selecting the “Redeem This Gift” button 233, or can browse other gifts by selecting the “See Other Gifts” button 235.

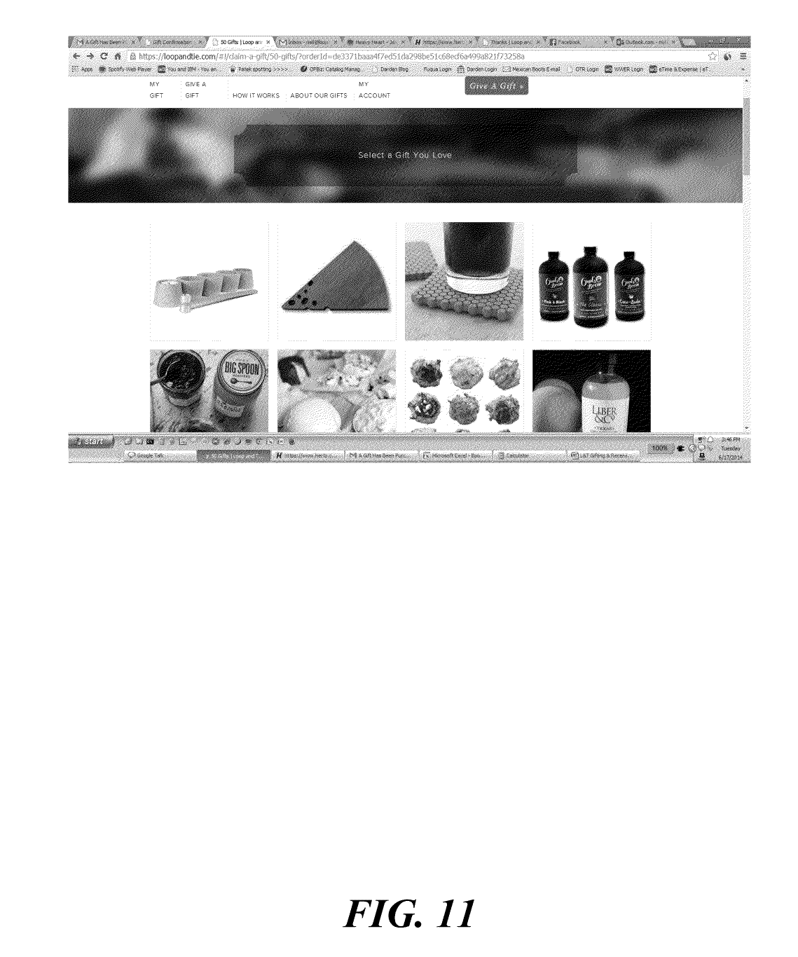

If the recipient selects the “See Other Gifts” button 235, the recipient's browser launches the URL associated with the customized web page 237 created for the recipient, as described above. The customized web page 237, which is depicted in FIG. 11, includes a browsable gift gallery 239 that contains all of the gifts meeting the criteria (in the embodiment depicted, price point) specified by the gift giver. Notably, the price of the gifts are not revealed, thus avoiding one of the main social taboos associated with gift cards.

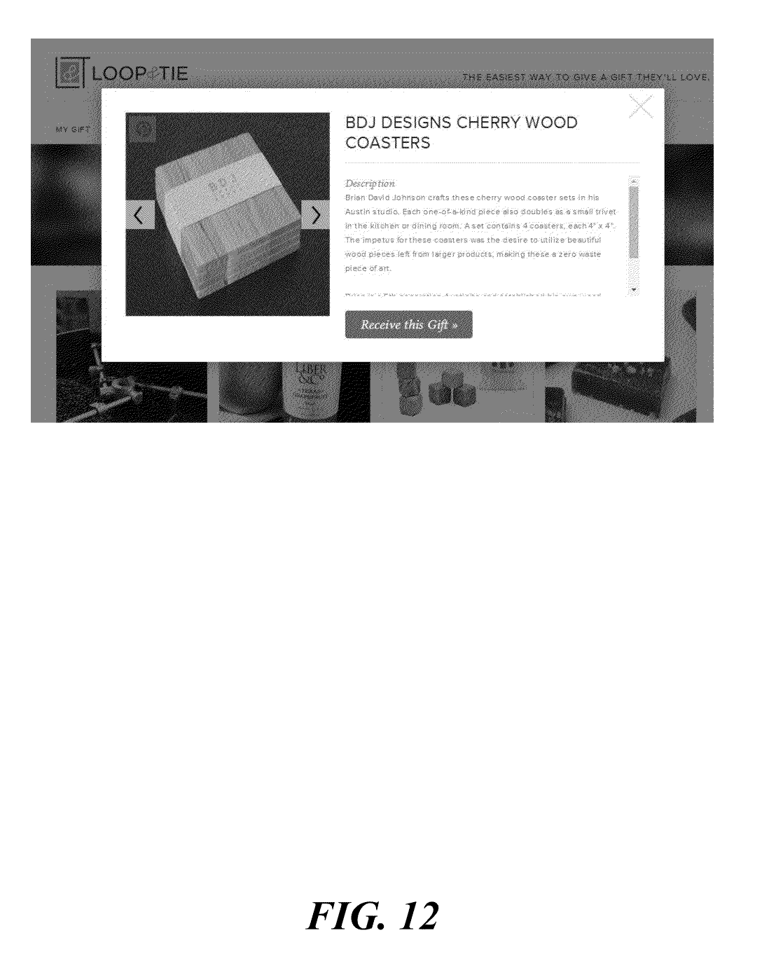

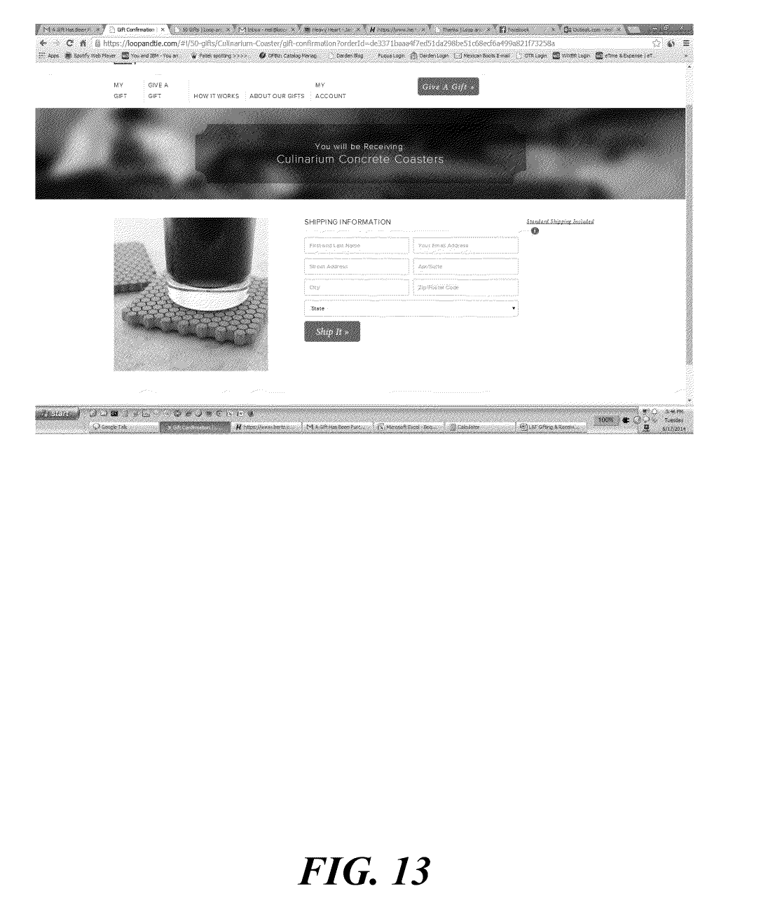

Selection of any item in the gift gallery 239 launches a pop-up window 241 containing a magnified picture of the item 243 and a detailed description 245 of the item, as depicted in FIG. 12. Navigational buttons 247 are provided which allow the user to browse the items in the gift gallery without exiting the magnified view. The user may select the “Receive This Gift” tab 249 to select the gift and proceed to the shipment page 251 depicted in FIG. 13.

As seen in FIG. 13, the shipment page 251 includes address fields 253 for the recipient. Upon entering information for these fields and selecting the “Ship It” tab 255, the gift is processed for shipping.

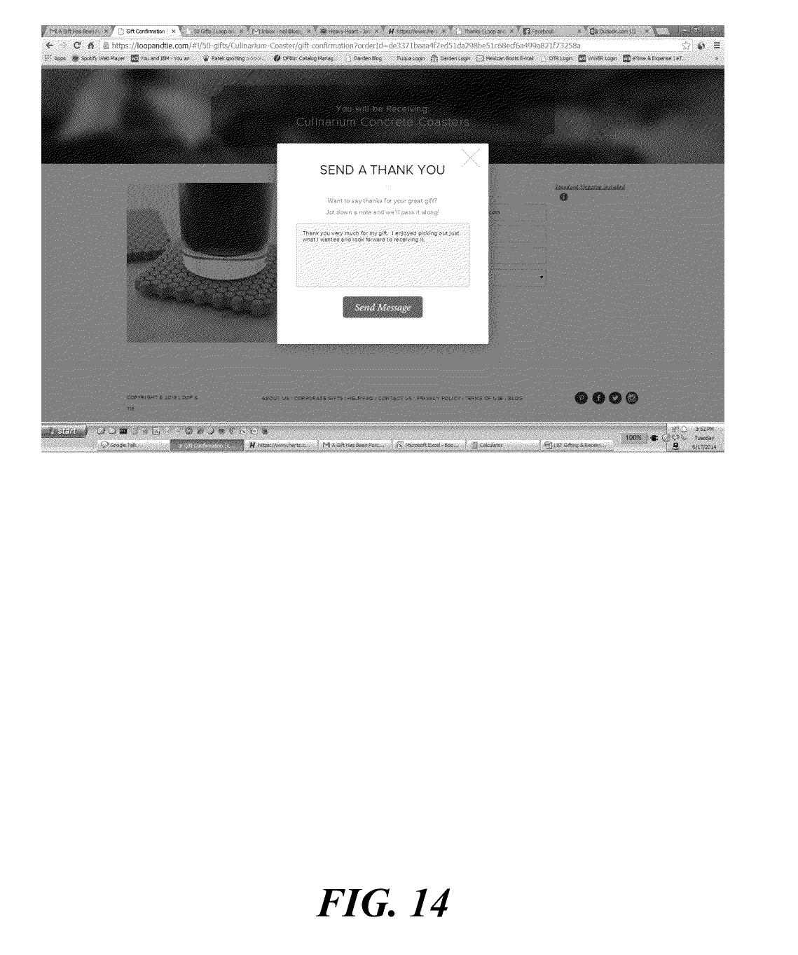

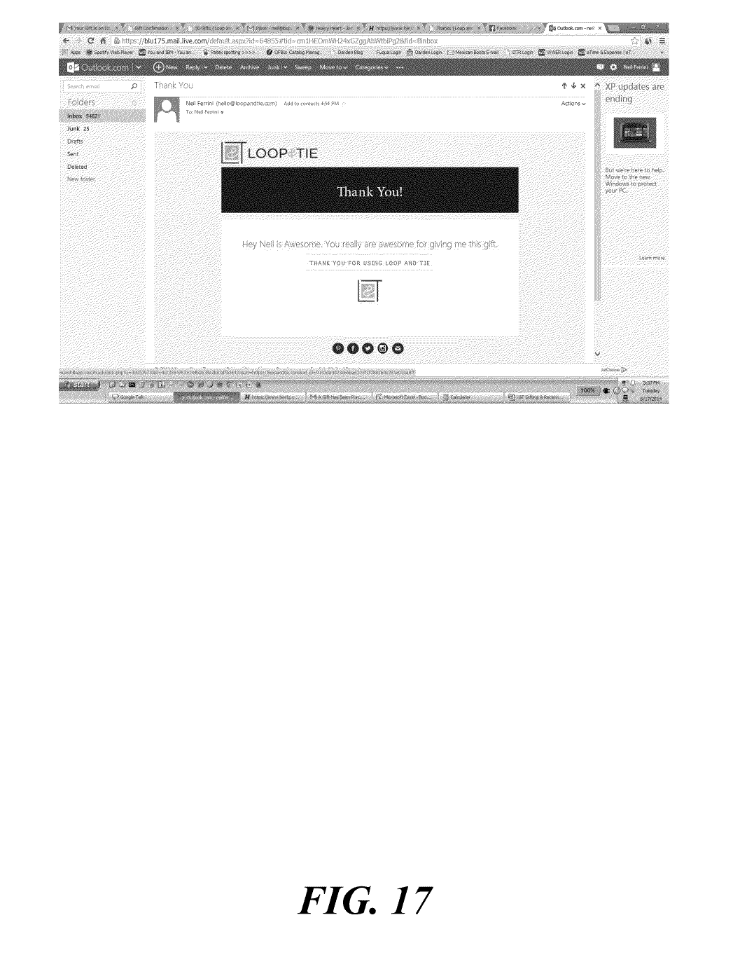

After selection of the “Ship It” tab 255, the recipient is prompted in a pop-up screen 257 to send a “thank you” note 259 to the gift giver as depicted in FIG. 14. The “thank you” note 259 preferably includes default text, which may be customized by the recipient. Selection of the “Send Message” tab 261 then causes the “thank you” note 259 to be sent to the gift giver. FIG. 17 depicts the corresponding “thank you” note 267 as received by the gift giver.

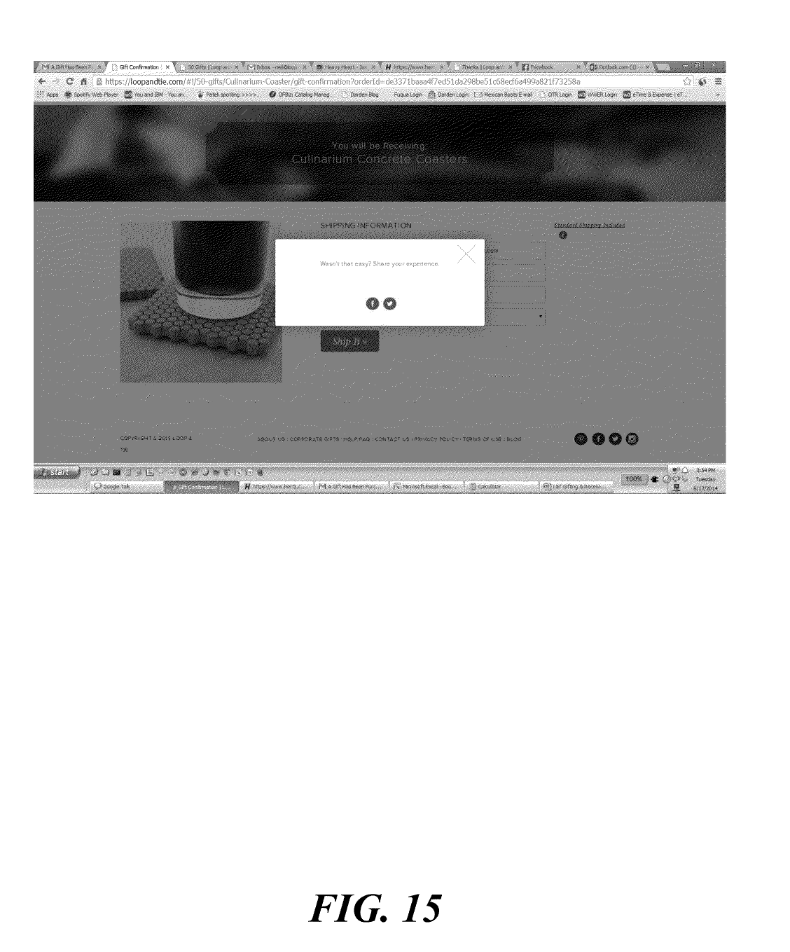

After selection of the “Send Message” tab 261 in FIG. 14, the recipient is prompted in a pop-up window 263, as seen in FIG. 15, to share their experience with the web-based gift solution via Facebook™ or Twitter™. The recipient can decline to do either by simply closing the pop-up window 263.

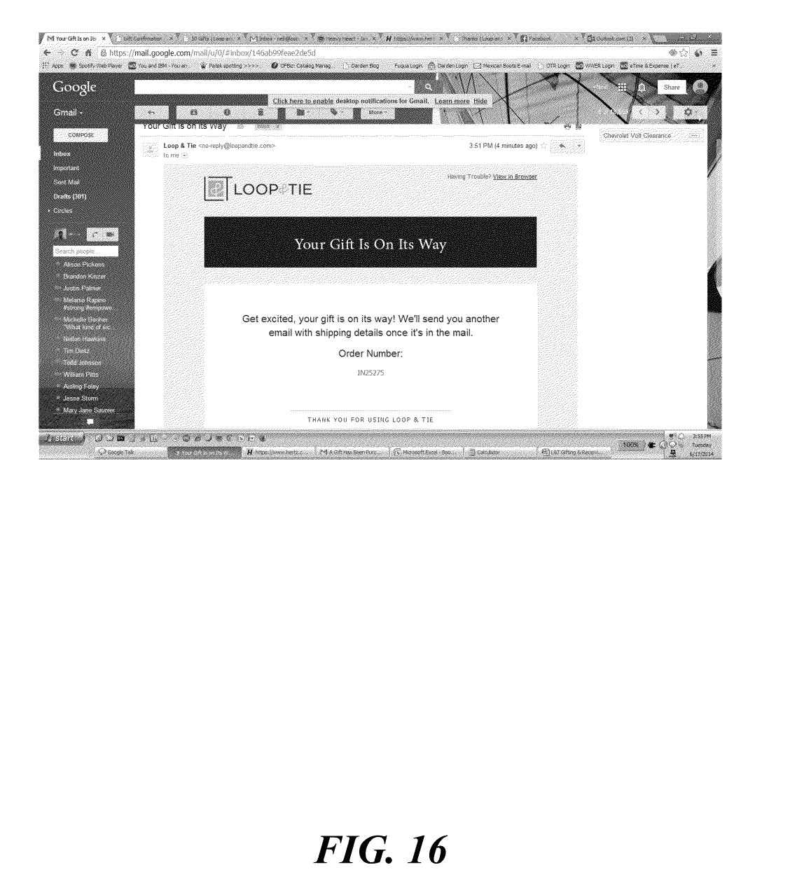

FIG. 16 depicts the confirmation email message 265 that is sent by the web-based gifting solution to the recipient after the recipient has finalized selection of a gift and provided shipping information. As seen therein, the message 265 includes an order number for tracking purposes. Preferably, a further email is sent to the recipient with shipping details once the selected gift is in the mail.

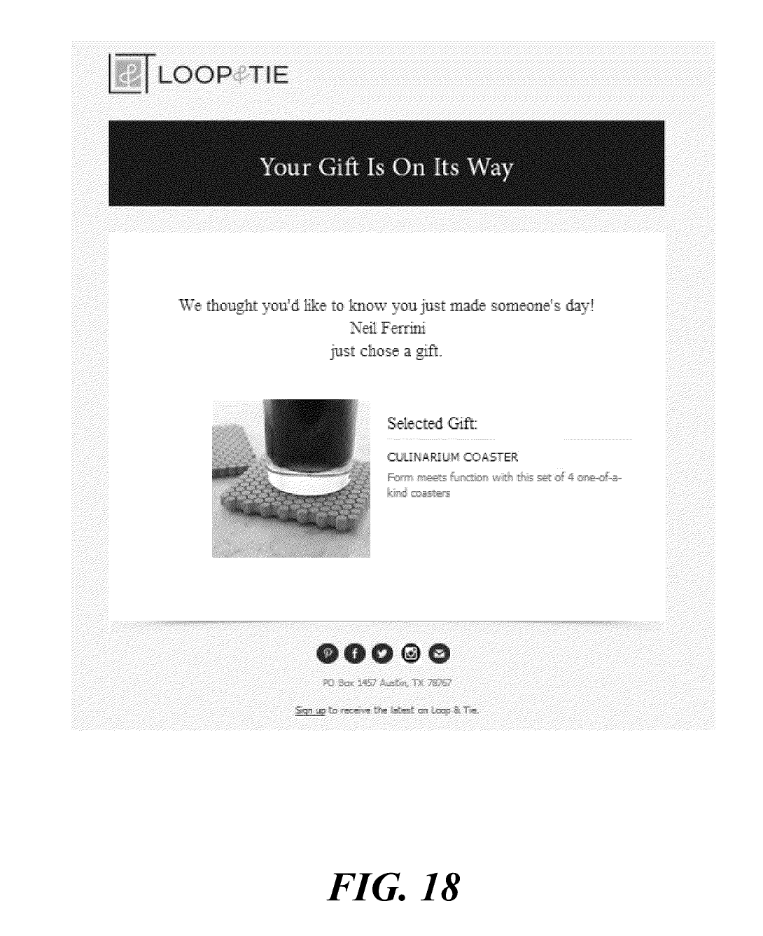

The web-based gifting solution described herein may generate other messages as well. For example, when a recipient selects a gift, the gift giver is notified of the occurrence of the selection, and of the specific gift chosen, by way of an email message of the type depicted in FIG. 18.

In the foregoing embodiment, gifts are organized or grouped by price point. However, one skilled in the art will appreciate that this embodiment may be modified to reflect other means of grouping or organizing gifts. These may include, for example, organizing gifts by gender, by type (e.g., baby gifts), by the event they are most suitable for (e.g., graduation, Father's Day, Mother's Day, Valentine's Day), or the like.

It will also be appreciated that the web-based gifting solution may be white-labeled to host gifts chosen by a client wishing to use the gift system to either sell their own products or to reach their gift recipient group. For example, the latter may include a law firm wishing to curate collections of golf gifts and ski gifts to share with its client base. The theme of gift collections may be modified to reflect the organizational requests of clients using the web-based solution.

As previously noted, some of the systems and methodologies described herein may be implemented by way of an application or client, which may be made available to consumers as both a mobile web application and a native application. Preferably, both species of the application provide the same look and feel to consumers.

The systems and methodologies described herein may be utilized for various occasions. For example, they may be utilized for traditional gifting occasions, such as birthdays and holidays, special occasions, when congratulations are due, or for a “thank you”.

The systems and methodologies described herein may also be utilized in professional contexts, such as customer and client gifting, employee appreciation, employee moral boosters, event planning, colleague appreciation, or to send or commemorate successful business interactions and transactions.

The systems and methodologies described herein may also be utilized in commercial contexts. For example, they may be used to express client/vendor appreciation, or in conjunction with product recommendations, vendor promotions or hotel hospitality.

The systems and methodologies described herein may also be utilized for spontaneous gifting and for miscellaneous purposes. These may include, for example, “just because” or “thinking of you” occasions, as a source of humor, or simply to create good karma.

The systems and methodologies disclosed herein may also be utilized for white labeling purposes, thus allowing them to be used, for example, by a merchant as a means of selling their products through organized gift collections. The systems and methodologies described herein may also be white labeled by an entity wishing to establish their own gift collections. For example, a car dealership may use the systems and methodologies disclosed herein to offer new car buyers their choice of company apparel as a “thank you” gift. It will be appreciated that the gifts in these instances may carry the name, brand, trademark, trade dress, or other indicia associated with the party on behalf of whom the white labeling services are being provided.

In a preferred embodiment of the systems and methodologies disclosed herein, although the gift giver has knowledge of what was spent on a gift, this information is hidden at all times from the recipient. This approach provides a more personalized feel than traditional gift cards, since no monetary value is ever associated with the gift.

As noted above, in a preferred embodiment, the systems and methodologies disclosed herein may be utilized to send gifts to multiple recipients (and possibly even a large number of recipients) in a single transaction. This feature is useful, for example, in a business setting, where a business owner may wish to send a gift to a list of clients. In some embodiments, the web-based gifting solution may be adapted to access a gift giver's address book for this purpose.

In some embodiments of the systems and methodologies disclosed herein, the recipient may be provided with various selectable options for a gift. For example, if the gift is a flask, the recipient may be permitted to choose an engraving, including various attributes thereof. For example, the recipient may be permitted to choose the text and font for the engraving. By way of further example, if the gift is a set of towels, the recipient may be permitted to choose a color and style.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A method for providing a gift to a recipient, comprising:
providing a website on which is displayed a set of gifts and a set of selectable gift categories;
receiving input from a gift giver which includes (a) a designated recipient for a gift, and (b) gift criteria which includes a gift category selected by the gift giver from said set of selectable gift categories;
creating a URL associated with the designated recipient upon which is displayed a subset of said set of gifts that meet the gift criteria input by the gift giver;
receiving, from the designated recipient, a selection of a gift from said subset of gifts; and
sending the selected gift to the recipient.

2. The method of claim 1, further comprising:
sending a message to the recipient which includes said URL.

3. The method of claim 2, wherein said message is selected from the group consisting of emails, text messages and physical cards.

4. The method of claim 2, wherein said message includes the name of the gift giver and a message from the gift giver.

5. The method of claim 2, wherein said message further includes a suggested gift in the subset of gifts that is suggested by the gift giver.

6. The method of claim 5, wherein said message further includes first and second links, wherein selection of said first link launches a first redemption page on which the suggested gift can be redeemed, and wherein selection of said second link launches a gift page on which any of the gifts in the subset of gifts can be browsed and selected.

7. The method of claim 6, wherein selection of a gift on said gift page launches a second redemption page on which the suggested gift can be redeemed.

8. The method of claim 7, wherein said first and second redemption pages query the recipient for a shipping address.

9. The method of claim 1, wherein each gift is assigned to one of a plurality of gift categories, and wherein the gift criteria includes one of said plurality of gift categories.

10. The method of claim 1, wherein each of said selectable gift categories is a price category, and wherein each gift in one of said selectable gift categories has the same purchase price.

11. The method of claim 1, wherein each of said gift categories is an event category selected from the group consisting of anniversaries and transaction closings.

12. The method of claim 1, wherein each of said gift categories is a theme-based category.

13. The method of claim 1, wherein receiving input from a gift giver includes (a) a plurality of designated recipients for a gift, and (b) gift criteria which includes a gift value selected by the gift giver from said set of selectable gift values.

14. The method of claim 13, wherein each of said plurality of designated recipients has gift criteria associated therewith, and wherein the criteria associated with a first of the plurality of recipients is distinct from the criteria associated with a second of the plurality of recipients.

15. The method of claim 1, wherein the website is provided by a first party and is operated on behalf of a second party pursuant to a white label agreement.

16. The method of claim 15, wherein the set of selectable gift categories are associated with the second party.

17. The method of claim 16, wherein the set of selectable gift categories are associated with the second party carry the second party's brand or trade dress.

18. A method for providing a gift to a recipient, comprising:
accessing a website associated with a business entity on which is displayed a set of gifts and a set of selectable gift categories; and
inputting, in response to a prompt from said web site, (a) a designated recipient for a gift, and (b) gift criteria which includes a gift category selected by the gift giver from said set of selectable gift categories;
wherein the website generates an electronic message to the designated recipient, wherein the electronic message contains a URL associated with the designated recipient upon which is displayed a subset of said set of gifts that meet the gift criteria input by the gift giver, wherein the website receives, from the designated recipient, a selection of a gift from said subset of gifts, and wherein the business entity sends the selected gift to the recipient.
